(19) United States
(12) Patent Application Publication
(10) Pub. No.: US 2026/0080036 A1
(43) Pub. Date: Mar. 19, 2026

(54) SYSTEMS AND METHODS FOR OMNIMODAL SENSING, MULTIMODAL DATA FUSION, AND RESILIENT COMMUNICATION FOR DIAGNOSTICS, SAFETY, AND AUTONOMOUS DECISION-MAKING

(71) Applicant: XGenesis, Grand Cayman (KY)

(72) Inventors: Mehron Massoud Talebi, Parkland, FL (US); Todd Darling, Parkland, FL (US); Pablo Meles, Weston, FL (US)

(73) Assignee: XGenesis, Grand Cayman (KY)

(21) Appl. No.: 19/372,644

(22) Filed: Oct. 29, 2025

Related U.S. Application Data
(63) Continuation-in-part of application No. 18/887,187, filed on Sep. 17, 2024.

(51) Int. Cl. G06F 18/25; G06F 21/62

(52) U.S. Cl. CPC G06F 18/251; G06F 21/6236; G06F 21/6245

(57) ABSTRACT

Systems, methods, and apparatus are disclosed for omnimodal sensing, data fusion, and autonomous decision-making across physical and digital domains. The disclosed architecture integrates biological-analog modalities including visual, auditory, olfactory, gustatory, and tactile sensors with symbolic or linguistic data sources such as text, structured records, or unstructured digital inputs. A data-fusion engine consolidates these heterogeneous streams into a unified context representation. A machine-learning inference model performs diagnostic, predictive, or safety-related reasoning from this representation. A distributed-ledger framework validates and preserves data provenance, and a resilient communication subsystem ensures command, control, and safety continuity through alternative channels such as cellular text, low-frequency radio, optical, acoustic, or magnetoelectric field-based transmission. This framework enables autonomous and semi-autonomous platforms including vehicles, humanoids, industrial robots, drones, and space systems to perceive, decide, and act with human-level contextual understanding even under degraded network conditions.

### CROSS-REFERENCE TO RELATED APPLICATIONS

This application is a Continuation-in-part of U.S. patent application Ser. No. 18/887,187 filed on Sep. 17, 2024 entitled IMPAIRMENT RECOGNITION AND INTERVENTION SYSTEM AND METHOD AND APPARATUS and claims priority thereto and incorporates such application herein in its entirety.

### FIELD

The present invention relates, in general, to methods and systems for sensing, and more particularly, to methods, systems, and devices that use omnimodal sensing, multimodal data fusion, and resilient communication for diagnostics, safety, and autonomous decision making.

### BACKGROUND

There is growing interest in diagnostics, safety, and autonomous decision making, including, but not limited to, detecting and intervening impaired driving conditions since impaired driving remains a significant public safety concern, contributing to a substantial number of traffic accidents and fatalities worldwide. Traditional methods of detecting impaired driving, such as roadside sobriety tests and breathalyzers, are limited in their scope and application. Other traditional methods of diagnostics, safety, and autonomous decision-making fail to make efficient and logical use of all the data that may be available.

### SUMMARY

Briefly stated, a specific implementation of the present embodiments involves a comprehensive system for detecting impaired driving using advanced sensor technologies, artificial intelligence, and secure data management. By incorporating multiple sensory inputs and leveraging cutting-edge machine learning techniques, this system serves as a pioneering solution for enhancing road safety and revolutionizing the approach to impaired driving detection.

In some embodiments, an impairment recognition and intervention system can include a vehicle sensor array having cameras for monitoring a driver and an environment surrounding a vehicle, audio sensors for capturing voice commands and ambient sounds, olfactory sensors for detecting alcohol or other substances, and motion sensors for detecting vehicle movement. The system can further include a sensor fusion module coupled to the vehicle sensor array for initial data aggregation and synchronization from data collected from the vehicle sensor array to provide fused data and for combining processed data from all sensors into a unified state estimate, a machine learning model or models for receiving the fused data as input to perform real-time analysis in detection of signs of impairment, a cloud processing and data storage component serving as a centralized platform for advanced data analysis, long term storage, and system management in communication with the machine learning model or models, an encryption engine for encrypting all stored data and encrypting communication with the cloud processing and data storage component, and a tamper-evident log of critical events in detection of signs of impairment using blockchain technology.

In some embodiments, the vehicle sensor array further includes tactile sensors in the form of pressure-sensitive surfaces on steering wheels and pedals.

In some embodiments, the vehicle sensor array further includes biometric sensors including heart rate monitors and skin conductance sensors for physiological data. In some embodiments, the vehicle sensor array further include biometric sensors that comprise a photoplethysmography (PPG) sensor integrated into the steering wheel that measures heart rate and heart rate variability, and a galvanic skin response (GSR) sensor that detects changes in skin conductivity indicative of stress or anxiety.

In some embodiments, the vehicle sensor array includes tactile sensors in the form of pressure-sensitive surfaces on steering wheels and pedals and biometric sensors including heart rate monitors and skin conductance sensors for physiological data.

In some embodiments, the cameras include high-resolution CMOS sensors with infrared capabilities for effective operation in various lighting conditions including a driver-facing camera to monitor facial expressions, eye movements, eye-lid movements, and head position, and a forward-facing camera for capturing road conditions and a vehicle's trajectory.

In some embodiments, the audio sensors further include beamforming microphone arrays and AI-powered speech analysis algorithms enabling enhanced voice command recognition and enhanced detection of speech patterns indicative of impairment.

In some embodiments, the olfactory sensors include a combination of metal oxide semiconductor (MOS) sensors and electrochemical fuel cells to detect the presence of alcohol and other volatile organic compounds associated with impairment.

In some embodiments, the olfactory sensors include nanosensor arrays using biomimetic principles.

In some embodiments, the motion sensors include a 6-axis inertial measurement unit (IMU) for detecting erratic driving behaviors including swerving, sudden braking, and inconsistent speed control.

In some embodiments, the sensor fusion module include a high-performance system-on-chip (SoC) with integrated Field Programmable Gate Array (FPGA) fabric for low-latency sensor interfacing and preliminary data processing.

In some embodiments, the sensor fusion module includes a neuromorphic computing elements enabling real-time, low-power analysis of complex multimodal sensor inputs.

In some embodiments, the sensor fusion module forms a part of a local processing unit (LPU) that combines inputs from the vehicle sensor array providing a fusion process in multiple stages including low-level fusion for time synchronization and initial data alignment, mid-level fusion for performing sensor-specific processing and feature extraction, and high-level fusion using Extended Kalman Filter (EKF) for combining processed data from the vehicle sensor array into a unified state estimate.

In some embodiments, the machine learning models include Convolutional Neural Networks (CNNs) for analyzing visual data, detecting signs of fatigue or distraction in a driver's face and monitoring a vehicle's position on the road, Recurrent Neural Networks (RNNs) for processing time-series data from motion sensors, and identifying patterns indicative of erratic driving, and Gradient Boosting Models for combining features from multiple sensors and making overall impairment assessments.

In some embodiments, the system further includes an AI model training port that enables secure, encrypted training of models using packaged data which occurs in a Trusted Execution Environment (TEE), generating a cryptographic proof of proper training and data consumption.

In some embodiments, the cloud processing and data storage component further includes a data ingestion pipeline, stream processing, batch processing, a machine learning pipeline, and an Application Programming Interface (API) layer.

In some embodiments, the blockchain technology includes smart contracts, a consensus mechanism, private data collections, chaincode to handle logging of impairment detection events, and integration with trusted execution environments (TEEs).

In some embodiments, a method of impairment recognition and intervention includes the steps of collecting sensor data using a vehicle sensor array, combining the sensor data using a sensor fusion module coupled to the vehicle sensor array for initial data aggregation and synchronization from data collected from the vehicle sensor array to provide fused data and for combining processed data from all sensors into a unified state estimate, performing real-time analysis in detection of signs of impairment using a machine learning model or models that received the fused data as inputs, performing advanced data analysis, long term storage, and system management in communication with the machine learning model or models using a cloud processing and data storage component serving as a centralized platform, encrypting all stored data and encrypting communication with the cloud processing and data storage component using an encryption engine, and providing a tamper-evident log of critical events in detection of signs of impairment using blockchain technology.

In some embodiments, the method further automatically disables or brings a vehicle to a safe stop in response to the detection of signs of impairment.

In some embodiments, the method combines inputs from the vehicle sensor array providing a fusion process in multiple stages including low-level fusion for time synchronization and initial data alignment, mid-level fusion for performing sensor-specific processing and feature extraction, and high-level fusion using Extended Kalman Filter (EKF) for combining processed data from the vehicle sensor array that provides a unified state estimate.

In some embodiments, a system includes a plurality of sensors configured to capture heterogeneous data streams, the plurality of sensors comprising one or more of: (a) one or more visual sensors; (b) one or more auditory sensors; (c) one or more olfactory sensors; (d) one or more gustatory sensors; (e) one or more tactile sensors; and (f) symbolic or linguistic data sources including text, structured electronic records, and unstructured written or digital inputs. The system can further include a data-fusion engine configured to integrate the heterogeneous data streams into a unified multimodal representation, a machine-learning model trained to perform diagnostic, predictive, or safety-related inferences based on the unified representation, a distributed-ledger or blockchain module configured to validate, secure, and preserve data provenance across modalities, and a resilient communication subsystem. The resilient communication subsystem can be configured to sustain secure command, control, or data exchange in the absence of primary network connectivity, the subsystem can include at least one of: (a) a cellular short-message or control-channel interface; (b) a low-frequency radio or peer-to-peer mesh transceiver; (c) an optical signaling interface; (d) an acoustic signaling interface; or (e) a magnetoelectric field-based transmission interface for data exchange under constrained or subterranean conditions.

In some embodiments, the symbolic or linguistic data comprise electronic health records, laboratory reports, educational or performance logs, or other structured or unstructured documents.

In some embodiments, textual or symbolic inputs are fused with at least one biological modality selected from visual, auditory, olfactory, gustatory, or tactile data to improve diagnostic or contextual accuracy.

In some embodiments, the machine-learning model dynamically weights symbolic or linguistic data relative to biological sensor inputs based on contextual relevance.

In some embodiments, the resilient communication subsystem authenticates transmissions via cryptographic keys anchored within the distributed ledger.

In some embodiments, the system further includes one or more autonomous or semi-autonomous platforms selected from the group consisting of: (a) ground vehicles; (b) humanoid or service robots; (c) industrial robotic manipulators; (d) aerial drones or unmanned aircraft or unmanned, semi-autonomous, or crewed systems; (e) marine or maritime systems or unmanned, semi-autonomous, or crewed vehicles surface vessels, submarines, submersible robots, or floating or fixed ocean platforms; and (f) extraterrestrial or orbital exploration devices.

In some embodiments, the machine-learning model generates safety, navigational, or behavioral inferences controlling the one or more autonomous or semi-autonomous platforms.

In some embodiments, multimodal sensory data are processed locally at the edge for latency reduction, privacy preservation, and energy efficiency.

In some embodiments, the resilient communication subsystem transmits essential diagnostic or safety messages through low-bandwidth protocols suitable for operation during network isolation, emergency, or conflict scenarios.

In some embodiments, magnetoelectric signaling provides secure, interference-resistant communication between embedded or subterranean agents and surface or orbital control nodes.

In some embodiments, the communication subsystem supports peer-to-peer coordination among autonomous agents for cooperative safety or swarm-based decision-making.

In some embodiments, local inferences generated at the edge are aggregated into population-level anonymized models via federated learning, thereby preserving privacy and enabling collective intelligence without central data pooling.

In some embodiments, a system can include a plurality of sensors configured to capture heterogeneous data streams, the plurality of sensors including one or more of each of one or more of visual sensors, auditory sensors, olfactory sensors, gustatory sensors, tactile sensors; or symbolic or linguistic data sources including text, structured records, and unstructured written or digital inputs. The system can further include a data fusion engine configured to integrate the heterogeneous data streams into a unified representation, a machine learning model trained to perform diagnostic, predictive, or safety-related inferences based on the unified representation; and a blockchain or distributed ledger module configured to validate, secure, and preserve data provenance across modalities.

In some embodiments, the symbolic or linguistic data includes at least one of: electronic health records, laboratory reports, school performance logs, conservation notes, or other machine-readable documents.

In some embodiments, text input is combined with at least one biological modality (visual, auditory, olfactory, gustatory, or tactile) to increase diagnostic accuracy.

In some embodiments, symbolic or linguistic data streams are preprocessed using natural language processing (NLP) models prior to fusion.

In some embodiments, the data fusion engine dynamically weights symbolic or linguistic inputs relative to biological sensor inputs based on contextual relevance.

In some embodiments, the plurality of sensors includes one or more of at least visual sensors, auditory sensors, olfactory sensors, and symbolic or linguistic data sources including text, structured records, and unstructured written or digital inputs.

In some embodiments, the plurality of sensors includes one or more of visual sensors, auditory sensors, olfactory sensors, gustatory sensors, tactile sensors and sensors for reading or interpreting symbolic or linguistic data.

In some embodiments, a computer-implemented method can include receiving multimodal data from a plurality of sensors including at least one biological and one symbolic or linguistic modality, fusing the data into a unified context representation, inferring a diagnostic, predictive, or safety-related state using a trained machine-learning model, validating the inference via distributed-ledger recording, and when network connectivity is lost, transmitting or receiving critical control data via a resilient communication subsystem employing cellular, radio, optical, acoustic, or magnetoelectric signaling.

### BRIEF DESCRIPTION OF THE DRAWINGS

FIG. 1 illustrates a system architecture for an impairment recognition and intervention system with hardware and software components in accordance with the embodiments;

FIG. 2 is a flow diagram illustrating a method of impairment recognition and intervention in accordance with the embodiments.

FIG. 3 is a flow diagram illustrating a method of omnimodal sensing, multimodal data fusion, and resilient communication in accordance with the embodiments.

### DETAILED DESCRIPTION

The innovations and improvements described herein are presented in terms of specific implementations that address issues in detecting impaired driving. At the core of the system lies a multimodal sensor array that captures a holistic view of driver behavior and vehicle conditions. The system's primary focus is on collecting high-quality, real-time data continuously, driving its capabilities and ensuring the highest level of performance. To achieve this, the system addresses compelling safety needs while maintaining stringent data privacy, security, and user trust standards.

The potential impact of this groundbreaking multimodal system on road safety and related fields is immense. By focusing on early impairment detection and providing a continuous stream of valuable data, this system not only enhances immediate road safety but also contributes to long-term improvements in vehicle technology, driver education, and traffic management.

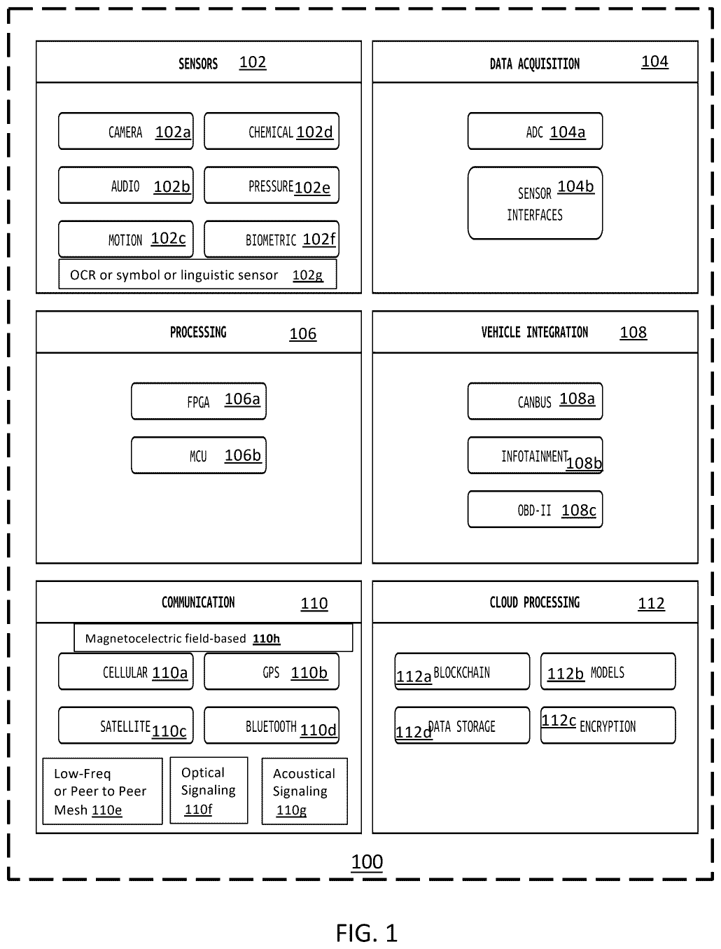

FIG. 1 illustrates a system architecture diagram of an impairment recognition and intervention system 100 having key hardware and software components in accordance with some of the embodiments. The system 100 is divided into six main sections: Sensors 102, Data Acquisition 104, Processing 106, Vehicle Integration 108, Communication 110, and Cloud Processing 112. Each section can include the relevant components. For example, the sensors 102 can include one or more of a camera 102a, an audio sensor 102b, a motion sensor 102c, a chemical sensor 102d, a pressure sensor 102e, and biometric sensors 102f. The sensors can further include an optical character recognition device (OCR) or symbolic or linguistic data sensor or source 102 that can read and recognize text, symbolic representations, or other characters. The data acquisition section 104 can include an analog to digital converter or ADC 104a and sensor interfaces 104b. The processing section 106 can include one or more of a field programmable gate array or FPGA 106a and MCU processing units 106b. The vehicle integration section 108 can include one or more of a CAN bus 108a, an infotainment module 108b, and OBD-II vehicle integration unit 108c. The communication section 110 can include one or more communication modules for cellular 110a, GPS 110b, satellite 110c, and Bluetooth 110d. In some embodiments, the one or more communication modules can include a cellular short-message or control-channel interface (see 110a); (b) a low-frequency radio or peer-to-peer mesh transceiver 110e; (c) an optical signaling interface 110f; (d) an acoustic signaling interface 110g; or (e) a magnetoelectric field-based transmission interface 110h for data exchange under constrained or subterranean conditions. The cloud processing layer or section 112 can include one or more modules for blockchain 112a, models 112b, encryption 112c, and data storage 112d. The modular design allows for the integration of various subsystems to enable comprehensive impaired driving detection and data analysis.

The system 100 can detect impaired driving using advanced sensor technologies, artificial intelligence, and secure data management. The embodiments utilize a multimodal sensor array to collect data on driver behavior and vehicle conditions. This data can be processed both locally and in the cloud, with machine learning models analyzing the information to detect signs of impairment. The system is designed to enhance road safety by identifying potential impairment in real-time and contributing to Artificial Intelligence or AI research through the collection and analysis of comprehensive driving data. Further note that the specific locations of where sensors are placed are not necessarily critical in all instances and will likely vary depending on the vehicle design. However, contact-dependent sensors are generally placed at key driver/operator contact points such as the steering wheel, shifter, and seat. Sensors that may be sensitive to external conditions (like air quality sensors) can be placed both inside and outside the vehicle to better differentiate internally-generated chemical signatures from externally-present ones. Audio sensors, including microphones, may be placed within the vehicle seat and at other points very close to the driver to minimize external noise interference. In this regard, chemical and environmental (olfactory) sensors can be placed both inside and outside of the vehicle (inside location not critical and can vary), and the microphones can be placed in the seat within the headrest and upper back area in conjunction with those placed around the dashboard to help isolate desired or targeted sounds and minimize external noise interference as previously noted.

Again, the key components in accordance with the embodiments can include a multimodal in-vehicle sensor array (102), a Local processing unit (LPU) (106) for edge computing, a cloud-based data processing and storage (112), machine learning models (112b) for impairment detection, secure data management using blockchain technology (112a and 112c), and user interfaces for alerts and system management.

The In-Vehicle Sensor Array of the sensors 102 forms the foundation of the impaired driving detection system 100. It can include multiple sensor types, each designed to capture specific aspects of the driving environment and driver state. This comprehensive approach ensures a holistic view of the driver's condition and behavior.

In some embodiments, the sensor array can include one or more among Visual sensors, Audio sensors, Tactile sensors, Motion sensor, and Biometric sensors. The camera can be High-resolution cameras for monitoring the driver and surrounding environment. The audio sensors can be microphones for capturing voice commands and ambient sounds. The olfactory sensors can be electronic noses for detecting alcohol and other substances. The tactile sensors can be pressure-sensitive surfaces on the steering wheel and pedals. The motion sensors can include accelerometers and gyroscopes for detecting vehicle movement. And the biometric sensor can include heart rate monitors and skin conductance sensors for physiological data.

The visual sensor system can include two primary cameras, namely, a driver-facing camera to monitor facial expressions, eye movements, eye-lid movements, and head position, and a forward-facing camera to capture the road conditions and vehicle's trajectory. These cameras use high-resolution CMOS sensors with infrared capabilities for effective operation in various lighting conditions.

Although not limited to the specific hardware implementations described herein, a potential implementation could utilize the Sony IMX577 CMOS sensor (8 MP, ½″ optical format) for the driver-facing camera and the ON Semiconductor AR0233 (2.3 MP HDR image sensor) for the forward-facing camera. Both sensors offer excellent low-light performance and high dynamic range, crucial for automotive applications. To improve upon the state-of-the-art, the system could incorporate event-based vision sensors, such as the Prophesee Metavision sensor. These sensors offer ultra-low latency and power consumption by only transmitting changes in the visual scene, potentially enabling faster and more efficient detection of sudden movements or changes in driver behavior. Other forward facing sensors can include LIDAR, radar, and ultrasonics among others if cost is not an issue.

Audio sensors can be strategically placed within the vehicle cabin to capture voice commands, detect signs of slurred speech, and monitor for unusual sounds that might indicate impaired behavior. Advanced noise cancellation algorithms are employed to filter out road and engine noise, ensuring clear audio capture.

For implementation in some embodiments, the system could use the Knowles SPH0645LM4H-B MEMS microphone, chosen for its high SNR and low power consumption. The audio stream could be processed by a Cirrus Logic CS47L90 Smart CODEC, which provides advanced DSP capabilities for noise cancellation and voice recognition. To push the boundaries of current technology, the system could incorporate beamforming microphone arrays and AI-powered speech analysis algorithms. This would enable more accurate voice command recognition and enhanced detection of speech patterns indicative of impairment, even in noisy vehicle environments.

In some embodiments, the olfactory system can use a combination of metal oxide semiconductor (MOS) sensors and electrochemical fuel cells to detect the presence of alcohol and other volatile organic compounds associated with impairment. These sensors are calibrated to detect concentrations well below the legal limit for driving.

A proposed implementation in some embodiments, could employ the Figaro TGS2620 alcohol sensor (MOS type) alongside the Sensirion SGP40 VOC sensor. These sensors would interface with a custom analog front-end (AFE) before connecting to the main processing unit. To advance beyond current technologies, the system could integrate emerging nanosensor arrays or “electronic noses” based on biomimetic principles. These advanced sensors could offer higher sensitivity, better selectivity, and the ability to detect a wider range of substances, potentially identifying various types of impairment beyond just alcohol consumption.

Tactile sensors integrated into the steering wheel and pedals can measure the driver's grip strength, pressure application, and overall interaction with the vehicle's controls. These sensors can use forcesensitive resistors (FSRs) to provide high-resolution pressure mapping.

In some embodiments, the implementation could use Interlink FSR 402 force-sensitive resistors arranged in a matrix configuration, interfaced with a high-speed microcontroller for initial signal conditioning and digitization. To improve upon existing systems, the tactile sensing could be enhanced with capacitive touch sensors and piezoelectric elements. This multi-modal approach to tactile sensing could provide more detailed information about the driver's interactions with the vehicle controls, potentially detecting subtle changes in grip patterns or tremors that might indicate impairment.

Motion sensors, including a 6-axis inertial measurement unit (IMU), can track the vehicle's movement patterns. This data is crucial for detecting erratic driving behaviors such as swerving, sudden braking, or inconsistent speed control.

The system could utilize the InvenSense ICM-20948 9-axis motion tracking device, which combines a 3-axis gyroscope, 3-axis accelerometer, and 3-axis magnetometer in a single package. To advance the state-of-the-art, the motion sensing system could be augmented with high-precision GNSS receivers and advanced sensor fusion algorithms. This would enable more accurate tracking of vehicle dynamics and could potentially detect subtle deviations from normal driving patterns that might be indicative of impairment.

Biometric sensors can monitor the driver's physiological state. A photoplethysmography (PPG) sensor integrated into the steering wheel measures heart rate and heart rate variability, while galvanic skin response (GSR) sensors detect changes in skin conductivity, which can indicate stress or anxiety.

For implementation, the system could use the Maxim Integrated MAX30102 for heart rate and SpO2 measurement, and the Texas Instruments LMP91000 for GSR measurement. To push the boundaries of current technology, the biometric sensing could be expanded to include non-contact sensors, such as millimeter-wave radar for respiration monitoring or thermal cameras for detecting changes in facial blood flow. These additional modalities could provide a more comprehensive picture of the driver's physiological state without requiring direct skin contact, potentially improving user acceptance and reliability.

All sensors in the array can be connected to a central sensor fusion board, which handles initial data aggregation and synchronization. This board uses a high-performance system-on-chip (SoC) with integrated FPGA fabric for low-latency sensor interfacing and preliminary data processing.

The system could be built around the Xilinx Zynq UltraScale+ MPSoCs, which combine FPGA fabrics with industry-standard ARM processors to provide a flexible platform for sensor fusion and preliminary data processing. In future implementations, the system could incorporate neuromorphic computing elements, such as Intel's Loihi chip, for more efficient processing of sensor data streams. This could enable real-time, low-power analysis of complex multimodal sensor inputs, potentially improving the system's ability to detect subtle indicators of impairment.

A hardware implementation of the embodiments can include a Local Processing Unit (LPU) as a core having a high-performance embedded computing platform, such as the NVIDIA Jetson AGX Xavier, for onboard real-time AI computation. This platform features an 8-core ARM CPU, a 512-core Volta GPU with Tensor Cores for accelerated AI computation, and a 32 GB of high-bandwidth memory.

The software stack of the LPU can be built on a real-time enabled Linux distribution, optimized for low-latency operations. The Robot Operating System 2 (ROS2) can serve as the middleware, facilitating seamless integration of the diverse sensor data streams and providing a flexible framework for implementing the system's processing pipeline.

Data fusion is a critical function of the LPU, combining inputs from the various sensors to create a comprehensive representation of the driver's state and the vehicle's condition. This fusion process can occur in multiple stages including: 1. Low-level fusion: Performed on the sensor fusion board using custom FPGA logic for time synchronization and initial data alignment; 2. Mid-level fusion: Initially implemented as ROS2 nodes, each dedicated to a specific sensor modality, performing sensor-specific processing and feature extraction. In a realized implementation, this would be integrated with vendor-specific software; and 3. High-level fusion: Utilizes an Extended Kalman Filter (EKF) to combine the processed data from all sensors into a unified state estimate.

Machine Learning Models. The embodiments can use several machine learning models. The fused data serves as input to a series of machine learning models deployed on the LPU. These models, optimized for edge inference using techniques such as quantization and pruning, perform real-time analysis to detect signs of impairment.

The models can include Convolutional Neural Networks (CNNs) for analyzing visual data, detecting signs of fatigue or distraction in the driver's face and monitoring the vehicle's position on the road; Recurrent Neural Networks (RNNs) for processing time-series data from motion sensors, identifying patterns indicative of erratic driving; and Gradient Boosting Models for combining features from multiple sensors and making overall impairment assessments.

In cases where potential impairment is detected, the system software may escalate the analysis to more advanced, albeit slower, models in the cloud via an active internet connection (such as Starlink or other providers). These cloud-based models can perform a more comprehensive assessment of the situation and, if necessary, provide verbal feedback or issue system commands to safely operate the vehicle on the driver's behalf. This multi-tiered approach ensures both rapid on-device detection and the ability to leverage more sophisticated analysis when needed, enhancing the overall safety and reliability of the system.

Security Measures. Security is a crucial aspect of the LPU's operation. All data processing occurs within the vehicle, with only aggregated results and necessary raw data transmitted to the cloud. Data encryption using AES-256 is applied to all stored data, and TLS 1.3 is used for secure communication with the cloud platform.

Data Packaging and AI Model Training. The system implements a data packaging mechanism that organizes the collected sensor data into high-quality, preprocessed packages. These packages can be dynamically requested by authorized entities based on specific categories, time frames, or other criteria. Additionally, the system includes an AI model training “port” that enables secure, encrypted training of models using this packaged data. This process occurs within a Trusted Execution Environment (TEE), generating a cryptographic proof of proper training and data consumption.

Cloud Processing and Storage. The cloud component of the impaired driving detection system serves as the centralized platform for advanced data analysis, long-term storage, and system management. It is designed to handle the large volumes of data generated by the fleet of vehicles equipped with the detection system, perform complex analyses that are beyond the capabilities of the in-vehicle units, and provide secure access to authorized parties for research and system improvement.

Architecture Overview. The cloud platform may be built on a scalable, containerized architecture such as Kubernetes for orchestration. This design allows for efficient resource allocation and easy scaling to handle varying loads. The core components of the cloud platform include: 1 Data Ingestion Pipeline; 2. Stream Processing; 3. Batch Processing; 4. Storage; 5. Machine Learning Pipeline; and 6. API Layer

Data Ingestion and Processing. The data ingestion pipeline uses a high-throughput message queue system, such as Apache Kafka, to handle incoming data streams from vehicles. This ensures reliable data ingestion even during spikes in network traffic or partial system outages. As part of the data ingestion process, the system implements real-time data packaging algorithms. These algorithms organize and preprocess the incoming sensor data into standardized formats, facilitating easier access and utilization for authorized downstream processes, including AI model training.

Stream processing is handled by Apache Flink, which performs real-time analysis on incoming data streams, updating driver risk profiles and triggering alerts when necessary. For more complex, retrospective analyses, Apache Spark is used to process large volumes of historical data, enabling the discovery of long-term trends and the training of more sophisticated machine learning models.

Storage Architecture. A multi-tiered storage system is implemented to balance performance and cost where the tiers can consist of:
Hot data: Recent, frequently accessed data is stored in a distributed time-series database like InfluxDB for fast querying.
Warm data: Less recent but still actively used data is stored in a columnar database like Apache Cassandra.
Cold data: Historical data is archived in object storage (e.g., Amazon S3) for long-term retention and compliance.

Machine Learning Pipeline. A robust ML pipeline is implemented using tools like MLflow for experiment tracking and model versioning. This pipeline continuously trains and updates the models used for impairment detection, leveraging the large-scale data available in the cloud. The ML pipeline also incorporates a secure data packaging and model training framework. This framework allows for the creation of curated datasets that can be used for training without requiring additional preprocessing. The pipeline includes a secure interface for initiating model training sessions within TEEs, ensuring data privacy and integrity throughout the process.

Security and Privacy Measures. To ensure data security and privacy, the cloud platform implements several key measures including End-to-end encryption for all data in transit and at rest; Role-based access control (RBAC) for system access; Data anonymization techniques for protecting driver privacy; and Regular security audits and penetration testing.

The cloud platform also integrates with a blockchain-based system for secure, transparent logging of critical events and data access. This provides an immutable audit trail, crucial for maintaining trust in the system and complying with regulatory requirements.

Blockchain Integration. The integration of blockchain technology into the impaired driving detection system serves two primary purposes: providing a secure, tamper-evident log of critical system events, and enabling transparent, controlled sharing of anonymized data for research and development purposes.

Blockchain Framework. The blockchain component is based on a permissioned blockchain framework, specifically the Hyperledger Fabric, chosen for its modularity, scalability, and support for private transactions. This framework allows for fine-grained access control while maintaining the benefits of distributed ledger technology.

The key components or aspects of the blockchain integration include:
1. Smart Contracts: Implemented in Go, these contracts govern data access rules, user consent management, and the logging of critical events.
2. Consensus Mechanism: The Practical Byzantine Fault Tolerance (PBFT) consensus algorithm is employed, providing high transaction throughput and immediate finality.
3. Private Data Collections: Sensitive data is stored off-chain in private data collections, with only hash references recorded on the blockchain.
4. Chaincode: Custom chaincode is developed to handle logging of impairment detection events, recording of user consent for data sharing, management of data access permissions, and maintaining an audit trail of all data access requests.
5. Integration with Trusted Execution Environments (TEEs): The blockchain nodes operate within Intel SGX enclaves to further enhance security and privacy.

System Integration. The blockchain component interacts with the rest of the system through a set of APIs, allowing for seamless integration with the cloud platform and local processing units. This integration enables real-time logging of critical events and provides a transparent mechanism for data sharing and access control. The system's data packaging and secure model training capabilities are designed to integrate seamlessly with external AI research and development platforms. This integration is achieved through a set of secure APIs that allow authorized entities to request specific data packages and initiate model training sessions within the system's TEEs.

Machine Learning Models. The effectiveness of the impaired driving detection system heavily relies on its machine learning models. These models are designed to process the multimodal sensor data and identify patterns indicative of driver impairment.

Model Types. The system employs a combination of models, each specialized for different aspects of impairment detection:
1.Visual Analysis Model: A convolutional neural network (CNN) processes images from the driver-facing camera to detect signs of fatigue, distraction, or intoxication.
2.Audio Analysis Model: A recurrent neural network (RNN) with attention mechanisms processes audio data to detect slurred speech, unusual vocal patterns, or signs of aggression.
3.Motion Analysis Model: A long short-term memory (LSTM) network analyzes time-series data from the vehicle's motion sensors to identify erratic driving patterns.
4. Physiological State Model: A gradient boosting model combines inputs from biometric sensors to assess the driver's overall physiological state.
5. Fusion Model: An ensemble model integrates outputs from all other models, along with contextual data, to make a final assessment of the driver's impairment level.

Training Process. These models are initially trained on large datasets of simulated and real-world driving data, including examples of both impaired and normal driving. The training process involves: Data preprocessing and augmentation to ensure model robustness; Transfer learning from pre-trained models where applicable; Hyperparameter optimization using techniques like Bayesian optimization; and Cross-validation to ensure generalization across different driving conditions.

Continuous Learning. Once deployed, the models continue to learn and improve through a federated learning approach. This allows the system to adapt to new patterns and improve its accuracy over time without compromising individual driver privacy.

Secure Data Packaging and Model Training. This system introduces a data packaging mechanism to allow for the creation of high-quality, preprocessed data packages that can be securely shared with authorized researchers or AI developers. These packages are created dynamically based on specific requests, ensuring that only relevant and approved data is shared.

The AI model training port provides a secure environment for training models using this packaged data. By leveraging TEEs, the system ensures that the training process occurs in an isolated, encrypted environment. This approach prevents unauthorized access to the raw data while still allowing for external parties to securely develop their own models.

The process described above may work as follows in a potential implementation:
1.Data is continuously collected and preprocessed by the system.
2.Authorized entities can request specific data packages through a secure API.
3. The system dynamically creates the requested package, applying necessary anonymization and encryption.
4. The package is securely transferred to the AI model training port within a TEE.
5.Model training occurs within the TEE, with no direct access to the raw data.
6.Upon completion, the system generates a cryptographic proof of the training process, verifying that the expected data was used and the model was trained according to specified parameters.
7. The trained model can then be securely deployed back to the vehicle systems or used for further research and development.

Privacy and Security. Ensuring the privacy and security of driver data is paramount in the design and operation of the impaired driving detection system. The system implements a multi-layered approach to protect sensitive information.

Data Protection Measures. Key privacy and security measures include:
1.Data Encryption: All data, both at rest and in transit, is encrypted using industry-standard encryption algorithms.
2.Access Control: A robust role-based access control (RBAC) system is implemented across all components of the system.
3.Data Minimization: The system adheres to the principle of data minimization, collecting and retaining only the information necessary for its operation.
4.Anonymization and Pseudonymization: Personal identifiers are separated from the collected data and replaced with pseudonyms. Techniques such as k-anonymity and differential privacy are applied to aggregated data to prevent re-identification of individuals.
5. Consent Management: The system includes a comprehensive consent management framework, allowing drivers to control how their data is collected, used, and shared.
6. Secure Enclaves: Sensitive computations, including some machine learning inferences, are performed within secure enclaves (such as Intel SGX) to protect data even from the system operators.
7. Regular Audits: The system undergoes regular security audits and penetration testing to identify and address potential vulnerabilities.
8. Compliance: The system is designed to comply with relevant data protection regulations, including GDPR and CCPA.

Blockchain-Based Audit Trail. The system incorporates an internal blockchain to create a secure, transparent, and immutable audit trail of all critical system events and data access requests. This blockchain integration serves several key purposes:
1.Data Integrity: Each event or data access is recorded as a transaction on the blockchain, with a unique cryptographic hash. This ensures that the recorded information cannot be altered without detection, maintaining the integrity of the system's operational history.
2.Access Control: Smart contracts implemented on the blockchain manage and enforce access control policies. These contracts automatically validate user permissions before allowing access to sensitive data or system functions.
3. Consent Management: The blockchain records and manages user consent for data collection and sharing. Any changes to user preferences are logged as transactions, creating a clear and auditable history of consent.
4. Regulatory Compliance: The immutable nature of the blockchain helps in demonstrating compliance with data protection regulations. Auditors can verify the system's adherence to privacy policies and data handling procedures.
5. Incident Investigation: In the event of a system anomaly or suspected breach, the blockchain provides a tamper-proof record of all system interactions, facilitating thorough and reliable investigations.
6. Interoperability: The blockchain can serve as a standardized layer for sharing critical event data with other authorized systems or stakeholders, such as law enforcement or insurance providers, while maintaining data integrity and access controls.

The blockchain is integrated with the system's data processing pipeline, automatically logging relevant events and access requests. It interacts with the cloud platform and local processing units through secure APIs, ensuring that all critical operations are recorded in real-time.

Potential Applications and Benefits. The multimodal sensor system for impaired driving detection offers numerous potential applications and benefits beyond its primary function. These include, though are not limited to, the following:

Road Safety Enhancement. The system enables real-time detection and prevention of impaired driving incidents, leading to a significant reduction in traffic accidents and fatalities. This results in improved overall road safety for all users, creating a safer driving environment.

Advanced Driver Assistance Systems (ADAS). By integrating with existing ADAS, the system may provide more comprehensive driver monitoring capabilities. This integration enhances predictive capabilities for potential driving hazards and contributes to the development of safer, data-driven autonomous driving systems.

Insurance and Risk Assessment. Data-driven risk assessment capabilities for auto insurance providers may open up the potential for usage-based insurance models and can incentivize safe driving practices through more accurate premium calculations based on actual driving behavior.

Public Health and Research. The system facilitates large-scale data collection for impaired driving research. This wealth of data can provide invaluable insights into patterns and trends of impaired driving behaviors, informing public health policies and interventions related to substance abuse and road safety.

Law Enforcement and Legal Applications. The system can provide objective evidence for impaired driving cases, enabling more targeted and effective enforcement strategies. Additionally, the data and insights gained from the system can support the development and implementation of rehabilitation and prevention programs, addressing the root causes of impaired driving.

Future Work and Considerations. The multimodal sensor system for impaired driving detection represents a significant advancement in road safety technology. However, it is crucial to address challenges in various domains, including technological advancements, machine learning and AI improvements, privacy and ethical concerns, regulatory compliance, and system integration.

Key areas for future work and consideration include:
Continuous improvement of sensor technologies and exploration of new sensing modalities to enhance detection accuracy and reliability
Advancements in edge computing capabilities for more sophisticated on-device processing
Ongoing refinement of machine learning models to improve detection accuracy, reduce false positives, and develop more nuanced impairment detection techniques
Development of explainable AI models to increase transparency and trust in the system's decisions
Implementation of robust privacy-preserving techniques and addressing ethical considerations surrounding data use and misuse
Balancing individual privacy rights with public safety interests
Adaptation to evolving data protection and privacy regulations
Collaboration with policymakers to develop appropriate legal frameworks and address liability issues
Development of industry standards for impaired driving detection systems
Integration with broader intelligent transportation systems and smart city initiatives
Ensuring interoperability with various vehicle makes and models

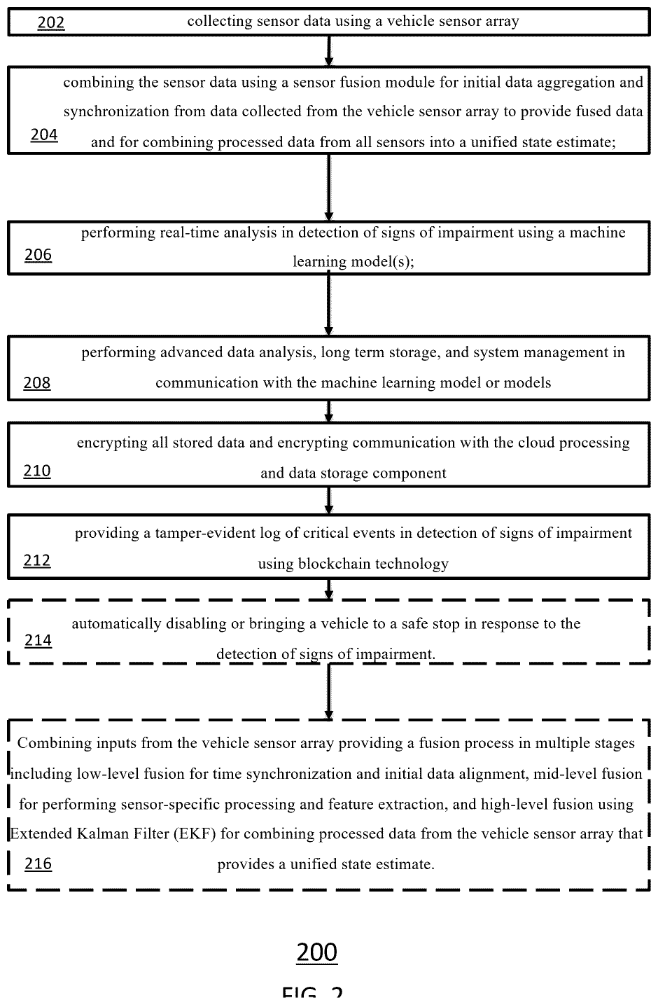

In some embodiments with reference to the flow chart of FIG. 2, a method 200 of impairment recognition and intervention includes the steps of collecting 202 sensor data using a vehicle sensor array, combining 204 the sensor data using a sensor fusion module coupled to the vehicle sensor array for initial data aggregation and synchronization from data collected from the vehicle sensor array to provide fused data and for combining processed data from all sensors into a unified state estimate, performing real-time analysis 206 in detection of signs of impairment using a machine learning model or models that received the fused data as inputs, at step 208, performing advanced data analysis, long term storage, and system management in communication with the machine learning model or models using a cloud processing and data storage component serving as a centralized platform, encrypting 210 all stored data and encrypting communication with the cloud processing and data storage component using an encryption engine, and providing 212 a tamper-evident log of critical events in detection of signs of impairment using blockchain technology.

In some embodiments, the method further at 214 automatically disables or brings a vehicle to a safe stop in response to the detection of signs of impairment.

In some embodiments, the method combines inputs at 216 from the vehicle sensor array providing a fusion process in multiple stages including low-level fusion for time synchronization and initial data alignment, mid-level fusion for performing sensor-specific processing and feature extraction, and high-level fusion using Extended Kalman Filter (EKF) for combining processed data from the vehicle sensor array that provides a unified state estimate.

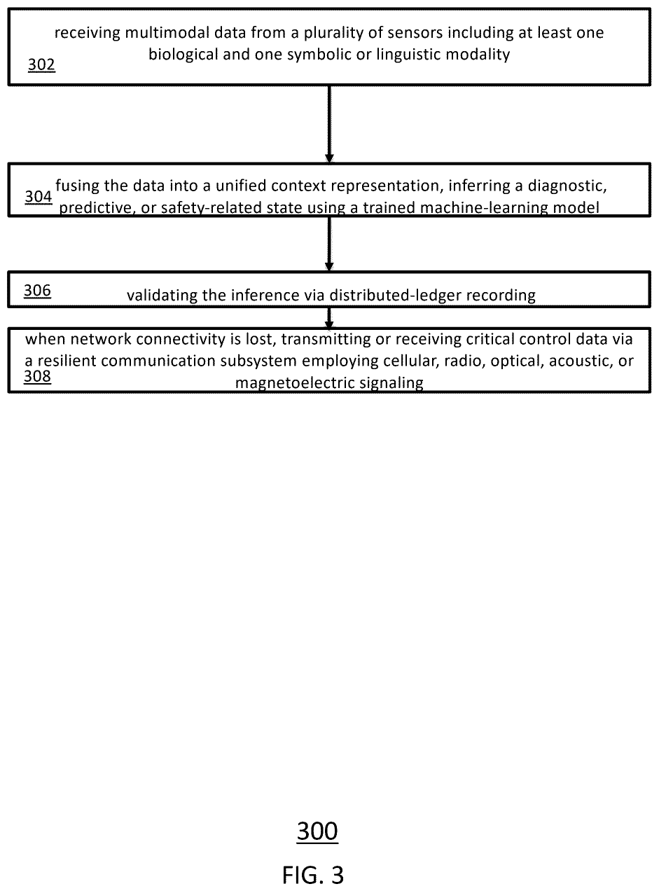

With respect to the flow chart of FIG. 3, in some embodiments, a computer-implemented method 300 can include receiving at 302 multimodal data from a plurality of sensors including at least one biological and one symbolic or linguistic modality, fusing at 304 the data into a unified context representation, inferring a diagnostic, predictive, or safety-related state using a trained machine-learning model, validating at 306 the inference via distributed-ledger recording, and when network connectivity is lost at 308, transmitting or receiving critical control data via a resilient communication subsystem employing cellular, radio, optical, acoustic, or magnetoelectric signaling.

The multimodal sensor system for impaired driving detection represents a significant advancement in road safety technology. By combining advanced sensor arrays, edge computing, machine learning, and blockchain technology, the system provides a comprehensive solution for real-time impairment detection and long-term safety improvements.

While the system presents a promising approach to combating impaired driving, it's important to note that it should be considered as part of a broader strategy that includes education, law enforcement, and policy measures and in yet other embodiments in a broader sense for generally performing autonomous decision making in any number of contexts, not just limited to vehicles. As vehicle technology continues to advance, particularly with the development of autonomous driving systems, the sensors and processing capabilities developed for this impaired driving detection system may find new applications in ensuring the safety and reliability of those systems as well.

By continuing to innovate and address challenges in areas such as privacy, ethics, and regulatory compliance, this system has the potential to significantly impact road safety and contribute to the broader fields of intelligent transportation systems and public health.

Some of the embodiments relate to autonomous and robotic systems. In certain embodiments, the system may be embodied within robotic, vehicular, or autonomous agents operating in terrestrial, aquatic, aerial, or orbital domains. The multimodal sensory architecture enables contextual awareness and hazard prevention analogous to biological cognition. Example implementations include humanoid caregivers, industrial robots, inspection drones, and planetary rovers utilizing the same multimodal fusion and safety logic as vehicle-based systems disclosed in the parent application.

The disclosed system in some embodiments may include a resilient communication subsystem designed to ensure continuity of mission-critical operation during degraded or absent network conditions. Such subsystem may employ cellular text or control-channel messaging, low-frequency radio, peer-to-peer mesh networking, optical signaling, acoustic transmission, or magnetoelectric field-based communication. This ensures data exchange between agents or between agents and supervisory control systems, even where traditional internet, satellite, or cloud infrastructures are unavailable. Magnetoelectric signaling may further enable subterranean, underwater, or shielded-domain communication where electromagnetic propagation is limited. Diagnostic or safety data recorded during such offline operation are later reconciled through blockchain verification upon restoration of full connectivity, preserving data integrity and chain-of-custody compliance.

Certain aspects of the embodiments involve edge autonomy and energy sustainability. In various embodiments, the inference and decision-making processes can occur at the edge, within the autonomous agent itself, reducing latency, conserving energy, and minimizing dependency on cloud compute infrastructure. This ensures continuous operation in power-constrained or connectivity-limited environments while preserving user privacy and regulatory compliance (HIPAA, GDPR, ISO/IEC 27001).

Certain aspects of the embodiments involve collective learning and ethical oversight. Some embodiments further contemplate secure, privacy-preserving data aggregation across distributed agents using federated learning. This approach allows collective intelligence to emerge across robotic, vehicular, and environmental networks without centralizing personally identifiable or sensitive data. The blockchain audit trail and magnetoelectric transmission options together establish an ethically aligned, resilient cognitive infrastructure suitable for deployment in healthcare, transportation, defense, and public safety.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
a plurality of sensors configured to capture heterogeneous data streams, the plurality of sensors comprising one or more of:
(a) one or more visual sensors;
(b) one or more auditory sensors;
(c) one or more olfactory sensors;
(d) one or more gustatory sensors;
(e) one or more tactile sensors; and
(f) symbolic or linguistic data sources including text, structured electronic records, and unstructured written or digital inputs;
a data-fusion engine configured to integrate the heterogeneous data streams into a unified multimodal representation;
a machine-learning model trained to perform diagnostic, predictive, or safety-related inferences based on the unified representation;
a distributed-ledger or blockchain module configured to validate, secure, and preserve data provenance across modalities; and
a resilient communication subsystem configured to sustain secure command, control, or data exchange in the absence of primary network connectivity, the subsystem comprising at least one of:
(a) a cellular short-message or control-channel interface;
(b) a low-frequency radio or peer-to-peer mesh transceiver;
(c) an optical signaling interface;
(d) an acoustic signaling interface; or
(e) a magnetoelectric field-based transmission interface for data exchange under constrained or subterranean conditions.

2. The system of claim 1, wherein the symbolic or linguistic data comprise electronic health records, laboratory reports, educational or performance logs, or other structured or unstructured documents.

3. The system of claim 1, wherein textual or symbolic inputs are fused with at least one biological modality selected from visual, auditory, olfactory, gustatory, or tactile data to improve diagnostic or contextual accuracy.

4. The system of claim 1, wherein the machine-learning model dynamically weights symbolic or linguistic data relative to biological sensor inputs based on contextual relevance.

5. The system of claim 1, wherein the resilient communication subsystem authenticates transmissions via cryptographic keys anchored within the distributed ledger.

6. The system of claim 1, further comprising one or more autonomous or semi-autonomous platforms selected from the group consisting of:
(a) ground vehicles;
(b) humanoid or service robots;
(c) industrial robotic manipulators;
(d) aerial drones or unmanned aircraft or unmanned, semi-autonomous, or crewed systems;
(e) marine or maritime systems or unmanned, semi-autonomous, or crewed vehicles surface vessels, submarines, submersible robots, or floating or fixed ocean platforms; and
(f) extraterrestrial or orbital exploration devices.

7. The system of claim 6, wherein the machine-learning model generates safety, navigational, or behavioral inferences controlling the one or more autonomous or semi-autonomous platforms.

8. The system of claim 1, wherein multimodal sensory data are processed locally at the edge for latency reduction, privacy preservation, and energy efficiency.

9. The system of claim 1, wherein the resilient communication subsystem transmits essential diagnostic or safety messages through low-bandwidth protocols suitable for operation during network isolation, emergency, or conflict scenarios.

10. The system of claim 1, wherein magnetoelectric signaling provides secure, interference-resistant communication between embedded or subterranean agents and surface or orbital control nodes.

11. The system of claim 1, wherein the communication subsystem supports peer-to-peer coordination among autonomous agents for cooperative safety or swarm-based decision-making.

12. The system of claim 1, wherein local inferences generated at the edge are aggregated into population-level anonymized models via federated learning, thereby preserving privacy and enabling collective intelligence without central data pooling.

13. A system comprising:
a plurality of sensors configured to capture heterogeneous data streams, the plurality of sensors including one or more of each of one or more of visual sensors, auditory sensors, olfactory sensors, gustatory sensors, tactile sensors; or symbolic or linguistic data sources including text, structured records, and unstructured written or digital inputs;
a data fusion engine configured to integrate the heterogeneous data streams into a unified representation;
a machine learning model trained to perform diagnostic, predictive, or safety-related inferences based on the unified representation; and
a blockchain or distributed ledger module configured to validate, secure, and preserve data provenance across modalities.

14. The system of claim 13, wherein the symbolic or linguistic data comprises at least one of: electronic health records, laboratory reports, school performance logs, conservation notes, or other machine-readable documents.

15. The system of claim 13, wherein text input is combined with at least one biological modality (visual, auditory, olfactory, gustatory, or tactile) to increase diagnostic accuracy.

16. The system of claim 13, wherein symbolic or linguistic data streams are preprocessed using natural language processing (NLP) models prior to fusion.

17. The system of claim 13, wherein the data fusion engine dynamically weights symbolic or linguistic inputs relative to biological sensor inputs based on contextual relevance.

18. The system of claim 13, wherein the plurality of sensors including one or more of at least visual sensors, auditory sensors, olfactory sensors, and symbolic or linguistic data sources including text, structured records, and unstructured written or digital inputs.

19. The system of claim 13, wherein the plurality of sensors including one or more of visual sensors, auditory sensors, olfactory sensors, gustatory sensors, tactile sensors and sensors for reading or interpreting symbolic or linguistic data.

20. A computer-implemented method comprising:
receiving multimodal data from a plurality of sensors including at least one biological and one symbolic or linguistic modality;
fusing said data into a unified context representation;
inferring a diagnostic, predictive, or safety-related state using a trained machine-learning model;
validating said inference via distributed-ledger recording; and
when network connectivity is lost, transmitting or receiving critical control data via a resilient communication subsystem employing cellular, radio, optical, acoustic, or magnetoelectric signaling.
